(19) United States
(12) Patent Application Publication
(10) Pub. No.: US 2011/0009112 A1
(43) Pub. Date: Jan. 13, 2011

(54) MULTIFUNCTION REMOTE CONTROL DEVICE FOR MOBILE TERMINAL AND METHOD USING THE SAME

(75) Inventors: Kyoung-Lae NOH, Suwon-si (KR); Giu-Yeol Kim, Suwon-si (KR); Dong-Yun Shin, Seongnam-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/831,388

(22) Filed: Jul. 7, 2010

(30) Foreign Application Priority Data
Jul. 7, 2009 (KR) 10-2009-0061501

(51) Int. Cl. G08C 17/02; G08C 19/16

(52) U.S. Cl. 455/420; 340/825.69

(57) ABSTRACT

A method and apparatus are provided for a multifunction remote control device, allows a user to display the contents of a mobile terminal on a larger screen, while retaining use of the mobile terminal's other functions. The method includes checking whether the mobile terminal is connected to the multifunction remote control device, running a multi-screen mode for composing a service environment in which control and call connection functions of the mobile terminal are executable, by implementing a wireless interface of the mobile terminal, and controlling basic functions and additional functions of the mobile terminal.

### PRIORITY

This application claims priority under 35 U.S.C. §119(a) to a Korean Patent Application filed in the Korean Intellectual Property Office on Jul. 7, 2009 and assigned Serial No. 10-2009-0061501, the disclosure of which is incorporated herein by reference.

### BACKGROUND OF THE INVENTION

1. Field of the Invention

The present invention relates generally to controlling a mobile terminal, and more particularly, to a multifunction remote control device that is connected to a mobile terminal in a wired or wireless manner and controls functions of the mobile terminal, and a method using the same.

2. Description of the Related Art

With the development of various technologies including wired/wireless communication technology, multimedia technology, technology for manufacturing hardware like Central Processing Units (CPUs) and memories, and power charging technology, miniaturization and improved performance of mobile terminals is now underway. These advances in mobile terminal-related technologies have led to improvements in existing products such as Personal Digital Assistants (PDAs) and Laptops, as well as the introduction of new-concept products such as smart phones, Netbooks, Mobile Internet Devices (MIDs) and Ultra Mobile PCs (UMPCs). Due to the development of such technologies, all or some of the functions, which were available only in desktop PCs in the past, are now available in mobile terminals, breaking down the boundaries between the mobile terminals and the desktop PCs.

FIG. 1 shows the normally used functions of a mobile terminal. As shown in FIG. 1, a mobile terminal not only offers a voice call function with the other party, but also offers various additional functions to provide pleasure and convenience to the user. While Internet searching, multimedia playback, communication with external devices and networks, utilization of graphic content such as games and document editing are given as examples of the functions in FIG. 1, many other functions may also be provided. Such functions may be selected and provided as additional functions depending on parameters such as screen size, resolution, input interface, power consumption, and computation capacity of the mobile terminal.

However, these functions, which are intended to offer the user pleasure and convenience, are difficult to perform in a size-limited mobile terminal like the smart phone and the PDA. Therefore, the user may suffer from many restrictions in enjoying the above functions when using the mobile terminal. For example, the limited size of a display of the mobile terminal causes inconvenience in visually displaying content such as internet web and video browsing, and the space-limited input unit makes it difficult to perform document editing. In addition, the limited battery capacity of the mobile terminal makes it impossible to use the above functions for long periods of time. Besides, mobile devices are often not compatible with external devices, such as PCs. These problems result in a contradiction where the smaller size of the mobile terminal is preferable for its portability but a large-sized display and high compatibility are needed for the user's convenience.

### SUMMARY OF THE INVENTION

An aspect of the present invention is to address at least the above-mentioned problems and/or disadvantages and to provide at least the advantages described below. Accordingly, an aspect of the present invention is to provide a method for providing convenience to a user by remotely controlling functions of a mobile terminal by means of a multifunction remote control device connected to the mobile terminal in a wired or wireless manner in order to increase usability of the mobile terminal in non-mobile environments such as the home or office.

In accordance with one aspect of the present invention, there is provided a multifunction remote control device for a mobile terminal, in which a wireless communication unit communicates with the mobile terminal or an external device using one of various types of wireless interfaces. A processing unit controls operations of, and interactions between, all or some components of the mobile terminal and the external device. An input/output interface determines whether to convert pertinent content of the mobile terminal if a user request is input into the mobile terminal.

In accordance with another aspect of the present invention, there is provided a method for controlling a mobile terminal in a multifunction remote control device. The method includes checking whether the mobile terminal is connected to the multifunction remote control device, running a multi-screen mode for composing a service environment in which control and call connection functions of the mobile terminal are executable, by implementing a wireless interface of the mobile terminal, and controlling key functions and additional functions of the mobile terminal.

### BRIEF DESCRIPTION OF THE DRAWINGS

The above and other aspects, features and advantages of the present invention will be more apparent from the following description taken in conjunction with the accompanying drawings, in which:

FIG. 1 is a diagram showing the normally used functions of a mobile terminal;

FIG. 2 is a diagram showing a service environment in which a mobile terminal and other devices connected to the mobile terminal are controlled by a multifunction remote control device according to an embodiment of the present invention;

FIG. 3 is a diagram showing an operation environment of a multifunction remote control device and its functions according to an embodiment of the present invention;

FIG. 4 is a flowchart showing a call exchange process of a multifunction remote control device according to an embodiment of the present invention;

FIG. 5 is an internal block diagram of a multifunction remote control device according to an embodiment of the present invention; and

FIG. 6 is a flowchart showing an operation of a multifunction remote control device according to an embodiment of the present invention.

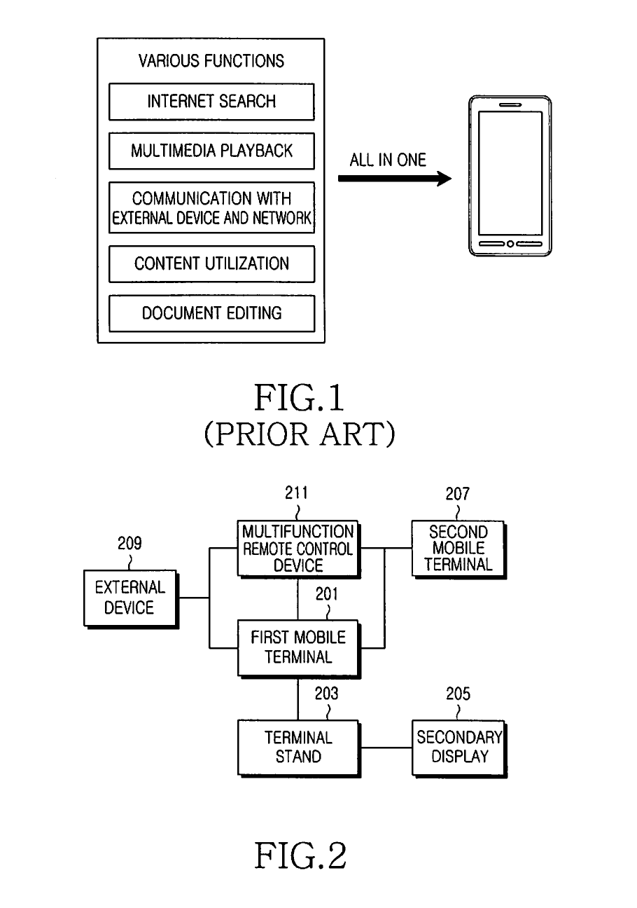

Throughout the drawings, the same drawing reference numerals will be understood to refer to the same elements, features and structures.

### DETAILED DESCRIPTION OF PREFERRED EMBODIMENTS

Preferred embodiments of the present invention will now be described in detail with reference to the accompanying drawings. In the following description, specific details of the configuration and components are provided to assist the overall understanding of certain embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

The present invention relates to a multifunction remote control device for remote control of a mobile terminal, and to controlling functions of the mobile terminal. A service environment in which the multifunction remote control device is included as one of its components will be described below.

FIG. 2 shows a service environment in which a mobile terminal and other devices connected to the mobile terminal are controlled by a multifunction remote control device according to an embodiment of the present invention. The service environment in FIG. 2 includes a first mobile terminal 201, a terminal stand 203, a secondary display 205, a second mobile terminal 207, an external device 209, and a multifunction remote control device 211.

Referring to FIG. 2, the first mobile terminal 201 may include portable mobile terminals such as a smart phone or a Personal Digital Assistant (PDA). Connections to all devices are made by way of the first mobile terminal 201, and once a connection to the multifunction remote control device 211 is made, key functions (and/or basic functions) and additional functions of the first mobile terminal 201 are controlled by the multifunction remote control device 211. The secondary display 205 may include any one of a digital TV, a PC monitor, a projector, and/or other displays, which are connected to allow a user to conveniently enjoy the functions of the first mobile terminal 201 on a larger screen, and may display the original content of the first mobile terminal 201 after changing the configuration of the user interface to be suitable to the larger screen.

The terminal stand 203 serves to connect the first mobile terminal 201 to the secondary display 205 such as a digital TV or a PC monitor, and also to recharge the first mobile terminal 201. The second mobile terminal 207 is connectable to the first mobile terminal 201 and/or the multifunction remote control device 211 in a wired or wireless manner, and may be connected for the purpose of information sharing such as a file-sharing transfer, and point-to-multipoint communication such as a call exchange. The external device 209 may include all connectable devices other than the secondary display 205 and the second mobile terminal 207. A PC and an internet phone, such as a Voice over Internet Protocol (VoIP) phone, may be examples of the external device 209.

The multifunction remote control device 211 serves to remotely control the key functions and the additional functions of the first mobile terminal 201. Its control is possible only when the first mobile terminal 201 is connected to the terminal stand 203. The multifunction remote control device 211 also controls the secondary display 205, the second mobile terminal 207 and the external device 209, which can be directly or indirectly connected.

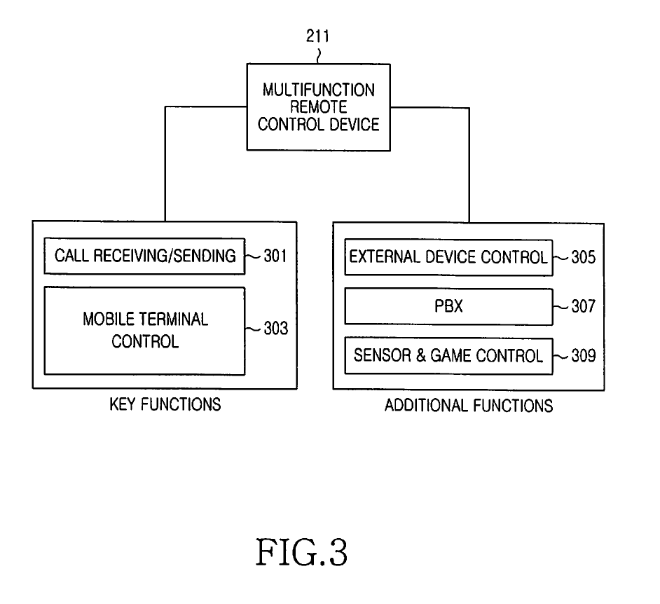

The multifunction remote control device 211 of the present invention controls two key functions and three additional functions, as shown in FIG. 3. FIG. 3 shows an operation environment of a multifunction remote control device and its functions according to an embodiment of the present invention. Referring to FIG. 3, the two key functions are main functions that are provided by default and are controlled by the multifunction remote control device 211, and include a call sending/receiving function 301 of the first mobile terminal 201, and a mobile terminal control function 303 such as the multimedia playback function included in the first mobile terminal 201. If the first mobile terminal 201 is connected, the multifunction remote control device 211 controls functions of the first mobile terminal 201 on behalf of the first mobile terminal 201 by controlling such key functions. The call sending/receiving function 301 may check information related to the call sending/receiving on the secondary display 205 connected to the terminal stand 203, and may check the busy information on the secondary display 205 when a call is made to another party.

The three additional functions controlled by the multifunction remote control device 211 in FIG. 3 are functions produced in combination with other devices, and include an external device control function 305, a Private Branch Exchange (PBX) function 307, and a sensor & game control function 309. The external device control function 305 connects with and controls the remotely controllable devices such as a digital TV, a Set-Top Box (STB), and a media player by means of the multifunction remote control device 211. These external devices may be connected to the multifunction remote control device 211 by a short-range wireless communication standard such as Infrared Data Association (IrDA), ZigBee and/or Bluetooth, with a composite control being possible by combining two or more communication standards.

The sensor & game control function 309 controls games by sensing a position and an operation of the multifunction remote control device 211 using a variety of sensors included in the multifunction remote control device 211. This allows the user to fully enjoy the interesting and emotional functions of the first mobile terminal 201. These sensors may include a gyro sensor, an acceleration sensor, an image sensor etc.

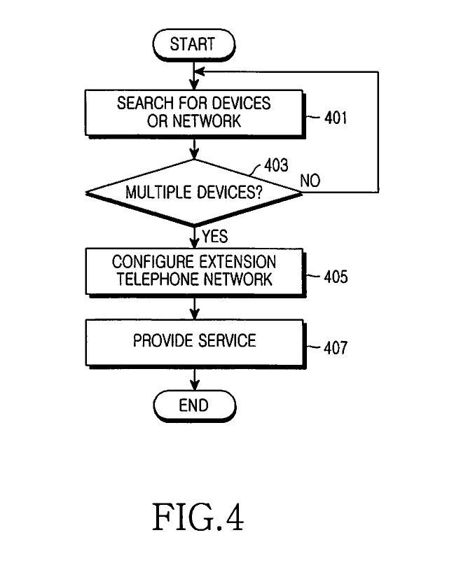

The PBX function 307 carries out small-scale private exchanges by connecting multiple mobile terminals located in a limited space by means of the multifunction remote control device 211. Specifically, the PBX function 307 may correspond to various exchange functions, including an extension call function between mobile terminals connected to a homogeneous or heterogeneous wireless network, a call waiting function for an incoming call simultaneously received at several mobile terminals, and other call processing functions. These functions may be extended by interlinking the multifunction remote control device 211 with an internet telephone network or public telephone network. A process of performing such call exchanges is shown in FIG. 4.

FIG. 4 shows a call exchange process of a multifunction remote control device according to an embodiment of the present invention. In step 401, the multifunction remote control device 211 searches for connectable devices and/or a wireless network to perform a call exchange function. In a preferred embodiment, connectable devices could be mobile terminals, and the wireless network could be an internet telephone network or a public telephone network. To perform the call exchange function, at least two devices and/or a wireless network should be searched. In step 403, the multifunction remote control device 211 determines whether multiple devices or a wireless network has been searched for and located. If not, the multifunction remote control device 211 repeats the search for the devices and/or wireless network until an activation condition of the call exchange function is satisfied. Upon satisfaction of the activation condition, the multifunction remote control device 211 configures an extension telephone network using the searched devices and/or wireless network in step 405. Upon receiving a request for an extension call rather than an incoming or outgoing service from/to the external network, the multifunction remote control device 211 provides a pertinent service using the configured extension telephone network in step 407. Types of services may include an extension call, call waiting, a multilateral call, etc. between mobile terminals connected to the multifunction remote control device 211, and these services are provided depending on the user's selection. The extension call, call waiting and multilateral call services are available when the multifunction remote control device 211, the first mobile terminal 201 connected to the terminal stand 203, and other external devices 209 are all connected to one another. These connections may be checked on the secondary display 205 connected to the terminal stand 203.

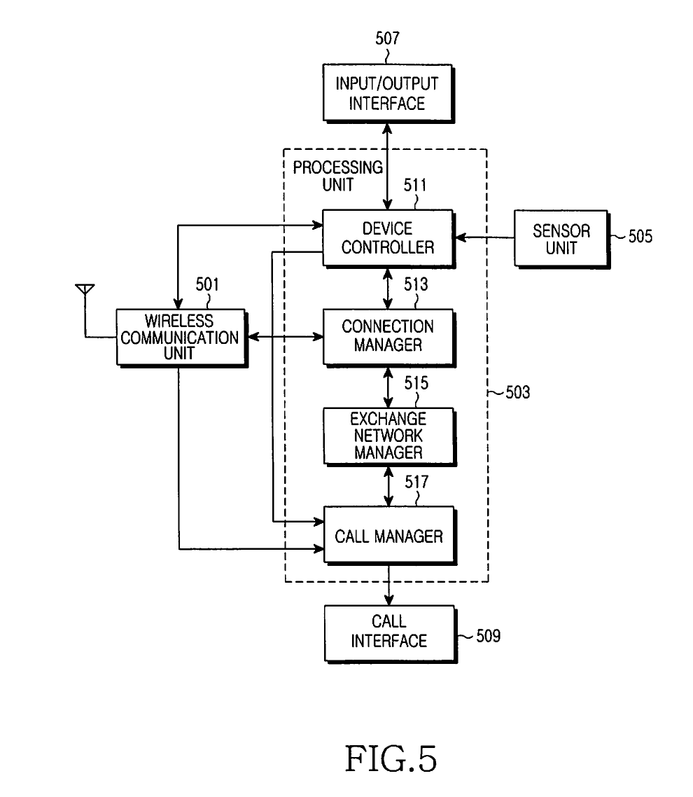

FIG. 5 shows an internal block diagram of a multifunction remote control device 211 performing the above-described functions according to an embodiment of the present invention. The multifunction remote control device 211 includes a wireless communication unit 501, a processing unit 503, a sensor unit 505, an input/output interface 507, and a call interface 509. The processing unit 503 includes a device controller 511, a connection manager 513, an exchange network manager 515, and a call manager 517.

Referring to FIG. 5, the wireless communication unit 501 performs communication with a mobile terminal or other devices using various wireless interfaces. The wireless interfaces used in the wireless communication unit 501 may include Bluetooth, Wireless Fidelity (WiFi), ZigBee, etc. . . . The wireless communication unit 501 is equipped with a module supporting the relevant interface to communicate with mobile terminals 201 and 207 and the external device 209. The wireless communication unit 501 may also be equipped with a module supporting multiple interfaces to use the multiple interfaces at the same time. For example, the wireless communication unit 501 may be equipped with a Bluetooth module to communicate with mobile terminals 201 and 207, and may also be equipped with a Bluetooth/WiFi module to access the wireless network and communicate with a communication device such as a VoIP phone while communicating with the mobile terminals. Such a module supporting multiple interfaces may be extended without limit depending on the user environment and usage, and is a requisite for implementing an exchange function for which multiple call channels could be used simultaneously.

The processing unit 503 serves to control operations of, and interactions between, all or some components of the multifunction remote control device 211, and between mobile terminals 201 and 207 and the external device 209 connected to the multifunction remote control device 211. The processing unit 503, as stated above, includes the device controller 511, the connection manager 513, the exchange network manager 515, and the call manager 517. These components are described below.

The connection manager 513 serves to manage connections with one or more mobile terminals 201 and 207 and the external device 209. For connections with mobile terminals 201 and 207 and the external device 209, an exchange of information such as the initial unique identifier is needed. Once their information is registered in the connection manager 513, mobile terminals and other devices may be automatically connected without the need for re-registration if they move to a pertinent area from outside the area.

The exchange network manager 515 configures an extension telephone network between two or more connected mobile terminals 201 and 207 in addition to managing connections and services between the mobile terminals 201 and 207. To this end, one or more mobile terminals could be connected to the connection manager 513. Otherwise, the exchange network manager 515 repeats searches for mobile terminals, other devices, or for a wireless network until the desired conditions are satisfied. Also, if a connection is made to an external telephone network, such as an IP network supporting a VoIP phone, the exchange network manager 515 may configure the extension telephone network including the external telephone network, and manage connections and services between mobile terminals 201 and 207 and the VoIP phone. In addition, if a new incoming call request is received at the second mobile terminal 207 connected to the connection manager 513 while a call is being processed by controlling the first mobile terminal 201 connected to the terminal stand 203, the exchange network manager 515 may perform call waiting or call forwarding depending on the user's preference.

The call manager 517 serves to manage and process incoming/outgoing calls received from mobile terminals 201 and 207. The call manager 517 manages and processes the incoming/outgoing call received from the first mobile terminal 201 connected to the terminal stand 203, and may also manage and process the incoming/outgoing call from the second mobile terminal 207 connected to the connection manager 513. If a new incoming call request is received at the second mobile terminal 207 connected to the connection manager 513 while a call is being processed by controlling the first mobile terminal 201 connected to the terminal stand 203, the call manager 517 may inform the exchange network manager 515 of the receipt of the incoming call request.

The device controller 511 controls functions of mobile terminals 201 and 207 and the external device 209 connected to the connection manager 513 and replies to incoming/outgoing calls received from the call manager 517, and if two or more incoming calls are received at the same time, the device controller 511 controls them.

The sensor unit 505 serves to recognize, handle and process information from various sensors including a position sensor, an acceleration sensor, and a pressure sensor. The sensor unit 505 is controlled by the device controller 511 in the processing unit 503, and its sensors may be used in additional applications supplied in or downloaded by mobile terminals 201 and 207, like games.

The input/output interface 507 includes a keyboard, a mouse, a touch screen, a digital TV, a computer monitor, etc. During data input, the input/output interface 507 is used to input desired user information to connected mobile terminals 201 and 207. During data output, the input/output interface 507 is used to exhibit the original content of mobile terminals 201 and 207 or to exhibit the content after changing a user interface or a resolution so as to be suitable for the output screen. The call interface 509 includes a speaker and a microphone, and is used for voice calls with another party when it is connected to other mobile terminals or an external device 209.

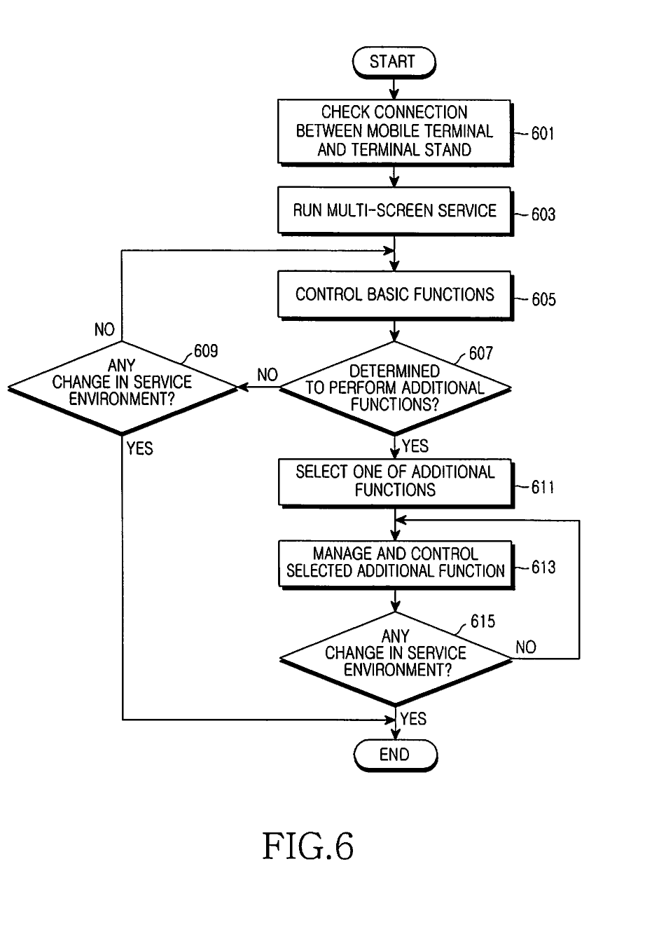

A process of controlling mobile terminals and external devices using the above components will be described in conjunction with FIG. 6, where an operation of a multifunction remote control device according to an embodiment of the present invention is depicted. In step 601, the multifunction remote control device 211 determines whether the first mobile terminal 201 is connected to the terminal stand 203. An operation of the multifunction remote control device 211 starts at the moment the first mobile terminal 201 is connected to the terminal stand 203, and the multifunction remote control device 211 determines the connection/non-connection by receiving a signal indicating the connection between the first mobile terminal 201 and the terminal stand 203 from the terminal stand 203. The terminal stand 203 starts recharging the mobile terminal 201 at the moment the first mobile terminal 201 is connected to the terminal stand 203. In step 603, the multifunction remote control device 211 runs a wireless interface for the first mobile terminal 201 to provide a multi-screen service. By running the wireless interface, the multifunction remote control device 211 creates a service environment in which control and call connection functions of the first mobile terminal 201 can be performed. When the wireless interface is running, the user may enjoy service from the first mobile terminal 201 on the secondary display 205. In this state, the first mobile terminal 201 should be connected to the terminal stand 203, and the terminal stand 203 must be connected to the secondary display 205.

In step 605, the multifunction remote control device 211 can control basic functions of the first mobile terminal 201. The basic functions of the first mobile terminal 201 include the call sending/receiving function 301 and the control function 303. The user may make a phone call using the multifunction remote control device 211 instead of the first mobile terminal 201, and control and enjoy content of the first mobile terminal 201 on the secondary display 205.

In step 607, the user can perform additional functions of the first mobile terminal 201 by means of the multifunction remote control device 211. Performance of the additional functions is determined depending on the connection status between devices, the requested service, and the operation conditions. For example, if two or more mobile terminals are connected to the multifunction remote control device 211, or the external device 209 is connected to the multifunction remote control device 211, the additional functions may be performed. The additional functions include a control function 305 for the external device 209 such as a VoIP phone, a call exchange, or a PBX function 307 for enabling calls between mobile terminals connected to the multifunction remote control device 211, and a sensor & game control function 309 for providing convenience to the user by controlling the sensors, and any other additional functions for user convenience.

If the user determines to perform the additional functions in step 607, the multifunction remote control device 211 selects one of the multiple additional functions in step 611, and manages and controls the selected additional function in step 613. In step 615, the multifunction remote control device 211 determines whether there is a change in the service environment, for example, whether the first mobile terminal 201 is disconnected from the terminal stand 203 or powered off. In the case of a change in the service environment, the multifunction remote control device 211 ends its operation, returning to the previous service environment in which the first mobile terminal 201 was disconnected from the terminal stand 203. However, in the absence of a change in the service environment, the multifunction remote control device 211 returns to step 613 and continues to manage and control the selected additional function.

If the user determines not to perform the additional functions in step 607, the multifunction remote control device 211 determines in step 609 whether there is a change in the service environment. In the case of a change in the service environment, the multifunction remote control device 211 ends its operation, returning to the previous service environment in which the first mobile terminal 201 was disconnected from the terminal stand 203. However, in the absence of a change in the service environment, the multifunction remote control device 211 returns to step 605 and continues to control the basic functions of the first mobile terminal 201.

As is apparent from the foregoing description, the present invention can simultaneously remotely control the key functions and the additional functions of mobile terminals, and can provide outputs to a digital TV or a PC monitor, enabling convenient use of the functions that the user couldn't enjoy on the small screen of the mobile terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A multifunction remote control device for a mobile terminal, comprising:
a wireless communication unit for performing communication with the mobile terminal or an external device using a wireless interface;
a processing unit for controlling operations of and interactions between one or more components of the mobile terminal and the external device; and
an input/output interface for determining whether to convert a pertinent content of the mobile terminal if a user request is input to the mobile terminal.

2. The multifunction remote control device of claim 1, wherein the wireless communication unit has a module with a plurality of wireless interfaces to perform communication with the mobile terminal or the external device.

3. The multifunction remote control device of claim 1, wherein the processing unit comprises:
a connection manager for managing a connection with the mobile terminal and the external device;
an exchange network manager for managing a connection and a service between respective mobile terminals by configuring an extension telephone network between the mobile terminal and the external device;
a call manager for managing and processing an incoming/outgoing call received from the mobile terminal; and
a device controller for controlling functions of the mobile terminal and the external device, replying to the incoming/outgoing call received from the call manager, and controlling a plurality of incoming call signals that are received at the same time.

4. The multifunction remote control device of claim 3, wherein the connection manager exchanges initial personal information for the connection with the mobile terminal and the external device, and supports a function in which once the personal information is registered in the connection manager, the mobile terminal and the external device are automatically connected without a need for re-registration upon their entry into a predetermined area.

5. The multifunction remote control device of claim 3, wherein if a plurality of mobile terminals and the external device are connected and a connection with an external telephone network is made, the exchange network manager configures the extension telephone network including the external telephone network, and manages a connection and a service between the mobile terminal and the external telephone network.

6. The multifunction remote control device of claim 3, wherein the exchange network manager performs a call waiting or a call forwarding depending on a user's choice if a new incoming call request is received at another mobile terminal connected to the connection manager while performing a call by controlling the mobile terminal.

7. The multifunction remote control device of claim 1, further comprising:
a sensor unit for sensing a position and an operation of the multifunction remote control device using one or more sensors; and
a call interface for performing a voice call with a sending or receiving user.

8. The multifunction remote control device of claim 7, wherein the sensor unit comprises a position sensor, an acceleration sensor and a pressure sensor, and the call interface comprises a speaker and a microphone.

9. A method for controlling a mobile terminal in a multifunction remote control device, comprising:
checking whether the mobile terminal is connected to the multifunction remote control device;
running a multi-screen service for composing a service environment in which control and call connection functions of the mobile terminal are executable, by implementing a wireless interface of the mobile terminal; and
controlling basic functions and additional functions of the mobile terminal.

10. The method of claim 9, wherein the mobile terminal is connected to the multifunction remote control device in a wired or wireless manner at the moment that the mobile terminal is connected to a terminal stand.

11. The method of claim 9, wherein the basic functions comprise a call function and a control function of the mobile terminal.

12. The method of claim 9, wherein the additional functions are created by combination with an external device, and comprise an external device control function, a private branch exchange function, and a sensor control function.

13. The method of claim 12, wherein the external device control function connects with and controls a remotely controllable external device, and the external device and the multifunction remote control device are connected by various communication schemes, and perform composite control using multiple communication schemes in combination at the same time.

14. The method of claim 12, wherein the private branch exchange function performs an extension call, call waiting and call forwarding between the mobile terminal and the external device connected to a homogeneous or heterogeneous wireless network, when the mobile terminal, the external device and the multifunction remote control device are connected to one another.

15. The method of claim 12, wherein the sensor control function senses a position and an operation of the multifunction remote control device using at least one sensor included in the multifunction remote control device.
